(19) United States
(12) Patent Application Publication
(10) Pub. No.: US 2011/0080378 A1
(43) Pub. Date: Apr. 7, 2011

(54) Eraser System

(75) Inventor: Chung-Wen Hsu, Kaohsiung (TW)

(73) Assignee: WALTOP INTERNATIONAL CORPORATION, HSINCHU (TW)

(21) Appl. No.: 12/651,963

(22) Filed: Jan. 4, 2010

(30) Foreign Application Priority Data
Oct. 2, 2009 (TW) 098218250

(51) Int. Cl. G06F 3/033

(52) U.S. Cl. 345/179; 178/19.01

(57) ABSTRACT

The present invention relates to an eraser system, and particularly relates to an independent eraser system for the digitizer coordinate system. The independent eraser system for the digital coordinate system is separated from the digitizer pen, and thus, the independent eraser system and the digitizer pen can be operated independently and simultaneously. The independent eraser system comprises an erasing function circuit and the erasing function circuit comprises a power supplier for providing the electric energy, an oscillating circuit for providing the electric signals and a converter for converting the electric signals into magnetic signals.

### FIELD OF THE INVENTION

The present invention relates to an eraser system, and particularly relates to an independent eraser system for the digitizer coordinate system.

### BACKGROUND OF THE INVENTION

In recent years, the digitizer coordinate system (or the tablet) is generally applied to draw and write for the user to input the complicated drawings or words with hand. However, as drawing or writing on a paper, some errors maybe happen or some words or drawing need to be changed when the user draws or writes on the tablet. Therefore, it is necessary for a device to erase part or full of the drawing or words written on the tablet.

Nowadays, the device used to erase the drawings and words on the tablet is so-called eraser or eraser system for the tablet. Referring to FIG. 1A, it is a perspective form diagram illustrating a conventional tablet 1 and a conventional digital pen 2. The conventional digital pen 2 comprises a writing part 3 for drawing and writing on a working area 5 of the tablet 1 and an erasing part 4 for erasing the drawing drawn on the working area 5 of the tablet 1 or the words written on the working area 5 of the tablet 1. However, the writing part 3 and the erasing part 4 are deposed on the two sides of the conventional digital pen 2 respectively so the conventional digital pen 2 needs to be reversed for erasing when the user uses the conventional digital pen 2 to erase drawings and words on the working area 5 of the tablet 1. Therefore, it is not smooth and convenient enough to be used the conventional digital pen 2 for erasing and the erasing part 4 of the conventional digital pen 2 can be use independently. Particularly when the user draws, the user often needs to draw with one hand and hold an eraser on another hand to erase small area or larger area of words or drawings for convenience as sketching on a paper. However, the conventional eraser (the erasing end 4 of the convention digital pen 2) can not achieve the foregoing effect. Therefore, it is necessary to provide an eraser system separated from the digital pen and capable of being used independently.

Besides, in recent years, the tablet system without battery (the digitizer coordinate system using a digital pen without battery) is developed and gradually promoted. In the conventional digital pen 2 showed in FIG. 1, no matter the writing part 3 or the erasing part 4 needs a battery for providing electric energy. Therefore, it is necessary to provide an eraser system capable of being applied to the digitizer coordinate system without battery to erase drawings or words which are drawn or written on the working area of a digitizer coordinate system without battery.

### SUMMARY OF THE INVENTION

An objective of this invention is to provide an eraser system to solve the problem that it is inconvenient to operate or use the eraser device of the conventional tablet because the eraser device of the conventional tablet can not be operated or used independently.

According to foregoing objective, the present invention provides a solution to the problem by providing an independent eraser system with a battery which is separated from a digital pen and is an independent system. The independent eraser system with a battery comprises an erasing function circuit. The erasing function circuit comprises a power supplier for providing the electric energy, an oscillating circuit for providing electric signals and a converter for converting the electric signals provided by the oscillating circuit into magnetic signals. The two nodes of the converter are connected with oscillating circuit. One node of the power supplier is connected with a first ground and another node of the power supplier is connected with the oscillating circuit. In the eraser system, the power supplier provides the electric energy to the oscillating circuit to emit the electric signals, and then, the electric signals are transmitted to the converter for converting the electric signals into the magnetic signals. The inductive loops in the tablet were coupled the magnetic signals emitted from the converter in the eraser system and calculate the position of the eraser system according to the intensity of the coupled signals. By detecting the frequency of the coupled signals, the processor of the tablet system distinguish whether the signals are the erasing signals or not. The independent eraser system with a battery is separated from the digital pen to be an independent device so the convenience of operating the independent eraser system with a battery is increased by this independent operation.

The present invention provides another way to solve foregoing problem by providing an independent eraser system without battery which is separated from the digital pen to be an independent system. The independent eraser system without battery comprises an erasing function circuit. The erasing function circuit comprises a resonance circuit for resonating with electromagnetic signals emitted from the tablet to store energy for supplying energy to the independent eraser system without battery, a frequency converter for converting the frequency of the signals emitted form the resonance circuit and an erasing function switch used to control the frequency converter to participate in resonance of the resonance circuit. The frequency converter is connected with one node of the resonance circuit and the erasing function switch deposed between the frequency converter and the resonance circuit. One node of the erasing function switch is connected with the resonance circuit and another node of the erasing function switch is connected with the frequency converter. When the independent eraser system without battery does not turn on the erasing function switch, the frequency converter does not participate in resonance of the resonance circuit. Therefore, the resonance circuit resonates with the signals emitted from the tablet for producing electric energy and the electric energy is stored in the resonance circuit for providing the electric energy or power to eraser system for emitting signals. By this way, it is not necessary for the eraser system to work with battery. When the erasing function switch is turned on, the frequency converter participates in resonance of the resonance circuit to convert the frequencies of the signals emitted from the independent eraser system without battery. Therefore, by detecting the coupled signals, the tablet can tell the signals is the erasing signals emitted from the independent eraser system without battery and then erasing is performed with the tablet system according to these signals.

Therefore, the effect achieved with the present invention is to provide an independent eraser system capable of being operated or used independently from the digital pen for convenient operation. Besides, this invention further provides an independent eraser system without battery and therefore, the tablet without battery can also has an independent eraser system capable of being operated or used independently from the digital pen.

### BRIEF DESCRIPTION OF THE DRAWINGS

FIG. 1 is a perspective form diagram illustrating a conventional tablet, a conventional digital pen and a conventional eraser.

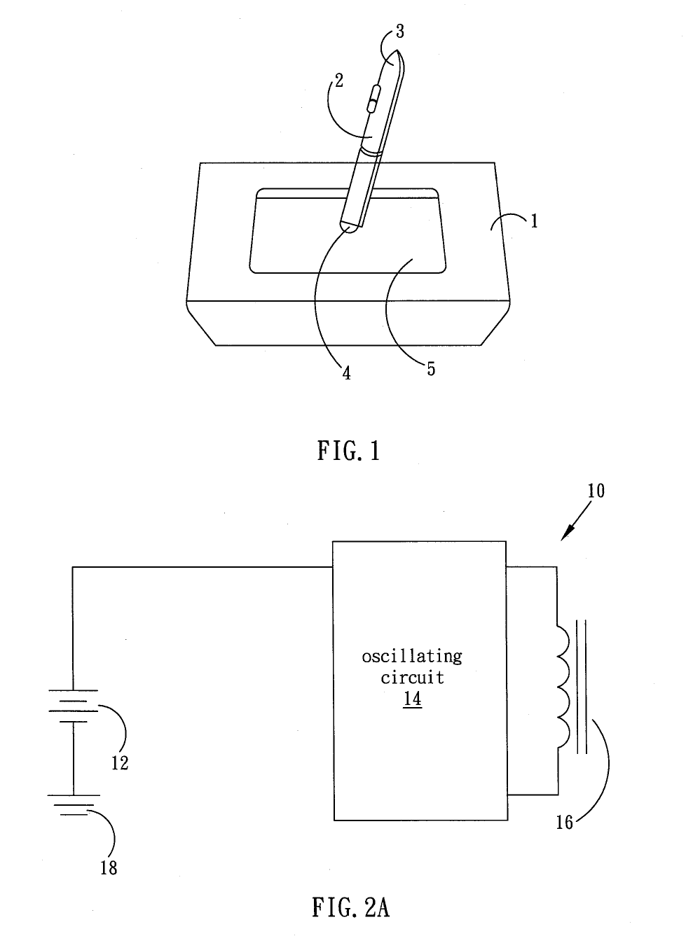

FIGS. 2A to 2C are diagrams illustrating circuit and structure of an independent eraser system with a battery in accordance with one embodiment of the present invention.

FIGS. 3A to 3B are diagrams illustrating circuit and structure of an independent eraser system with a battery in accordance with another embodiment of the present invention.

FIG. 4 is a diagram illustrating circuit and structure of an independent eraser system without battery in accordance with one embodiment of the present invention.

### DESCRIPTION OF THE EXEMPLARY EMBODIMENTS

Although the present invention will be described in accordance with the embodiments shown below, one of ordinary skill in the art will readily recognize that there could be variations to the embodiments and those variations would be within the spirit and scope of the present invention. Accordingly, many modifications may be made by one of ordinary skill in the art without departing from the spirit and scope of the appended claims.

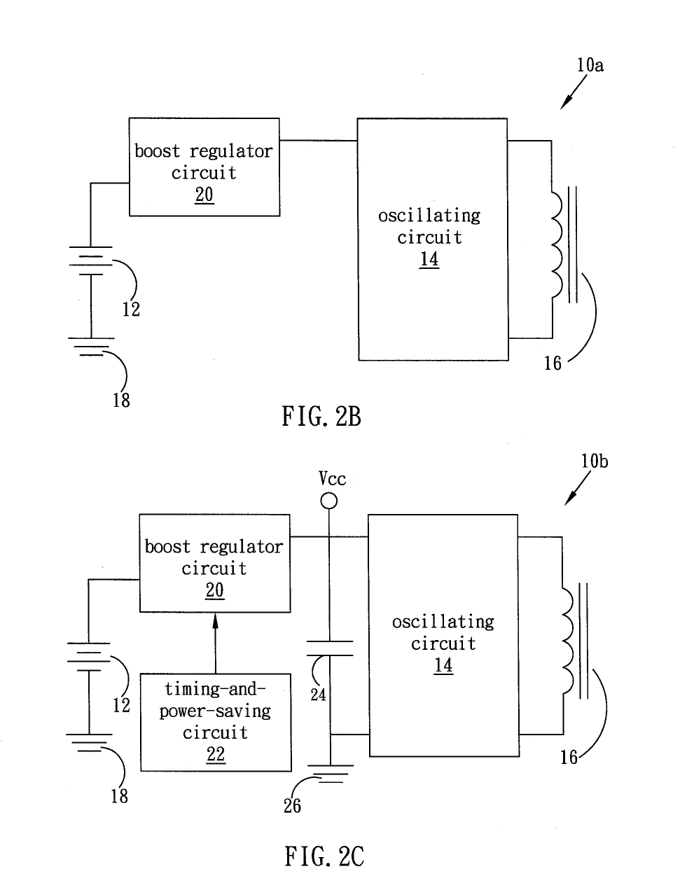

Referring to FIG. 2A, it is diagram illustrating an independent eraser system (or an erasing function circuit) with a battery in accordance with one embodiment of the present invention. The independent eraser system with a battery comprises an erasing function circuit 10. The erasing function circuit 10 comprises a power supplier 12 for providing the electric energy or power, an oscillating circuit 14 for providing electric signals and a converter 16 for converting the electric signals provided by the oscillating circuit 14 into magnetic signals. The two nodes of the converter 16 are connected with oscillating circuit 14. One node of the power supplier 12 is connected with a first ground 18 and another node of the power supplier 12 is connected with the oscillating circuit 14.

The eraser system (or erasing function circuit) 10 provides the electric energy or power to the oscillating circuit 14 by the power supplier 12 for emitting electric signals. The electric signals are transmitted to the converter 16 to be converted into the magnetic signals and then the magnetic signals are emitted by the converter 16. By detecting the intensity of the coupled signals of inductive loops in the tablet, the processor of the tablet system calculate the position of the independent eraser system. By detecting the frequencies of the coupled signals, the processor of the tablet system determines whether the signals are the erasing signals or not. If the tablet recognizes that the signals are the erasing signals, the erasing function is performed by the eraser system (or erasing function circuit) with the tablet. The independent eraser system with a battery 10 is separated and independent from the digital pen to be an independent device so it is different from the conventional eraser device which is deposed on the digital pen and can not be operated or used independently. Therefore, the independent eraser system with a battery 10 provide in this invention can be operated or used independently and the convenience of using or operating the independent eraser system with a battery 10 is increased and improved.

Furthermore, referring to FIG. 2B, a boost regulator circuit 20 is deposed between the power supplier 12 and the oscillating circuit 14 in the independent eraser system (or an erasing function circuit) with a battery 10a. One node of the boost regulator circuit 20 is connected with the oscillating circuit 14 and another node of the boost regulator circuit 20 is connected with the power supplier 12. The boost regulator circuit 20 is deposed between the power supplier 12 and the oscillating circuit 14 for supplying stable electric energy or power to the oscillating circuit 14. Therefore, the boost regulator circuit 20 eliminates or reduces the intensity variation of the signals emitted from the oscillating circuit 14 because of the dropping of the voltage of the power supplier 12.

Next, referring to FIG. 2C, a timing-and-power-saving circuit 22 is deposed in the independent eraser system (or an erasing function circuit) with a battery 10b to be connected with the boost regulator circuit 20. The timing-and-power-saving circuit 22 is used for controlling the independent eraser system (or an erasing function circuit) with a battery 10b into a power-saving mode after the independent eraser system (or an erasing function circuit) with a battery 10b is idle in a while. In the independent eraser system (or an erasing function circuit) with a battery 10b, the timing-and-power-saving circuit 22 counts the idle time of the independent eraser system 10b, in which the independent eraser system 10b is not used or operated, and then the timing-and-power-saving circuit 22 will shuts down the oscillating circuit 14 when the idle time counted by the timing-and-power-saving circuit 22, in which the independent eraser system 10b is not used or operated, exceeds the pre-defined idle time. Therefore, the independent eraser system (or an erasing function circuit) with a battery 10b will hibernates until the independent eraser system (or an erasing function circuit) with a battery 10b is used or operate again. By this way, the effect of power saving can be achieved.

Next, referring to FIG. 2C again, a stabilizer 24 is deposed in the independent eraser system (or an erasing function circuit) with a battery 10b. One node of stabilizer 24 is connected with Vcc power, and another node of the stabilizer 24 and the oscillating circuit 14 are connected with a second ground 26 together. When the oscillating circuit 14 needs larger electric current to work, the stabilizer 24 can provide enough electric current immediately to maintain stability of the power voltage of the oscillating circuit. The stabilizer 24 is a capacitor.

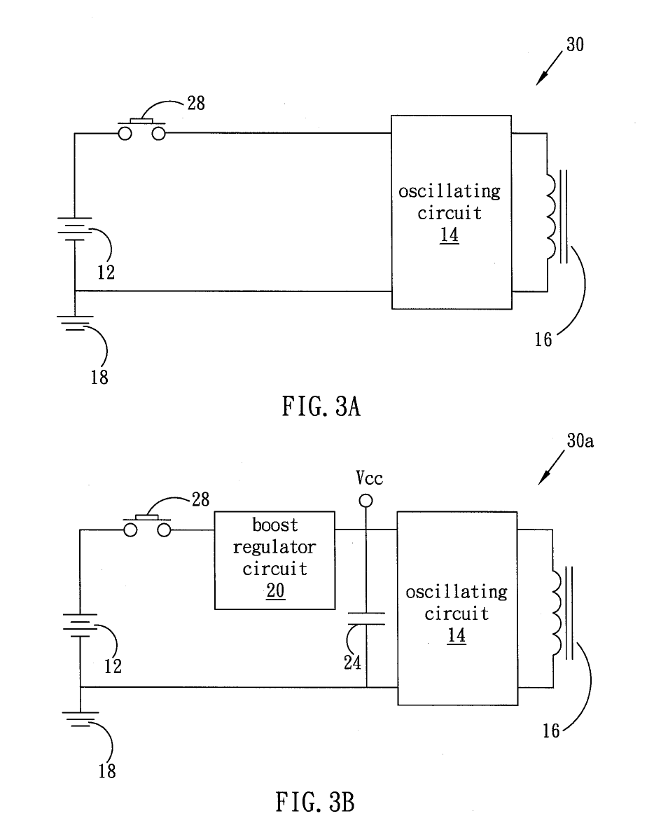

Referring to FIG. 3A, it is a diagram illustrating inner circuit and inner structure of an independent eraser system (or an erasing function circuit) with a battery in accordance with another embodiment of the present invention. The independent eraser system with a battery comprises an erasing function circuit 30. The erasing function circuit 30 comprises a power supplier 12 for providing the electric energy, an oscillating circuit 14 for providing electric signals and a converter 16 for converting the electric signals provided by the oscillating circuit 14 into magnetic signals. The converter 16, the oscillating circuit 14 and the power supplier 12 are connected with each other in parallel and the oscillating circuit 14 is deposed between the converter 16 and the power supplier 12. The converter 16, the oscillating circuit 14 and the power supplier 12 are connected with the first ground 18 together. Besides, the independent eraser system (or the erasing function circuit) 30 comprises a erasing function switch 28 deposed between the oscillating circuit 14 and the power supplier 12 for controlling the circuit between the oscillating circuit 14 and the power supplier 12 to be on or off.

The independent eraser system (or the erasing function circuit) 30 turns on the erasing function switch 28 for making the circuit between the power supplier 12 and the oscillating circuit 14 to be on. Therefore, the power supplier 12 provide the electric energy or power to the oscillating circuit 14 for emitting the electric signals, and then, the electric signals are transmitted to the converter 16 for converting the electric signals into the magnetic signals and the magnetic signals are emitted by the converter 16. By detecting the intensity of the coupled signals of inductive loops in the tablet, the processor of the tablet system calculate the position of the independent eraser system. By detecting the frequencies of the coupled signals, the processor of the tablet system determines whether the signals are the erasing signals or not. If the tablet recognizes that the signals are the erasing signals, the erasing function is performed by the eraser system (or erasing function circuit) with the tablet. The independent eraser system 30 is separated and independent from the digital pen to be an independent device so it is different from the conventional eraser device which is deposed on the digital pen and can not be operated or used independently. Therefore, the independent eraser system 30 provide in this invention can be operated or used independently and the convenience of using or operating the independent eraser system 30 is increased and improved.

Furthermore, referring to FIG. 3B, in the independent eraser system (or the erasing function circuit) 30a with a battery, a boost regulator circuit 20 is also deposed between the power supplier 12 and the oscillating circuit 14. One node of the boost regulator circuit 20 is connected with the oscillating circuit 14 and another node of the boost regulator circuit 20 is connected with the power supplier 12. The boost regulator circuit 20 is deposed between the power supplier 12 and the oscillating circuit 14 for supplying stable electric energy or power to the oscillating circuit 14. Therefore, the boost regulator circuit 20 eliminates or reduces the intensity variation of the signals emitted from the oscillating circuit 14 because of the dropping of the voltage of the power supplier 12. Furthermore, a stabilizer 24 is deposed in the independent eraser system (or the erasing function circuit) 30a with a battery. One node of stabilizer 24 is connected with Vcc power, and another node of the stabilizer 24, the oscillating circuit 14 and the power supplier 12 are connected with the first ground 18 together. The stabilizer 24 is a capacitor. When the oscillating circuit 14 needs larger electric current to work, the stabilizer 24 can provide enough electric current immediately to maintain stability of the power voltage of the oscillating circuit.

In the independent eraser systems (or the erasing function circuits) with a battery illustrated in FIGS. 3A and 3B, the erasing function switch 28 is a rotating switch deposed at one side of the independent eraser systems with a battery 30 and 30a, or the erasing function switch 28 is a pressure switch or a button deposed at one side of the independent eraser system with a battery 30 and 30a, but not limit. However, the erasing function switch can be design to be any form according to the requirement for operating or using.

In both of FIGS. 2A-2C and FIGS. 3A-3B, the power supplier is a battery, and it can be an alkaline battery, a dry battery, a rechargeable battery or other kinds of batteries as the independent eraser system requires. The converter 16 is a coil.

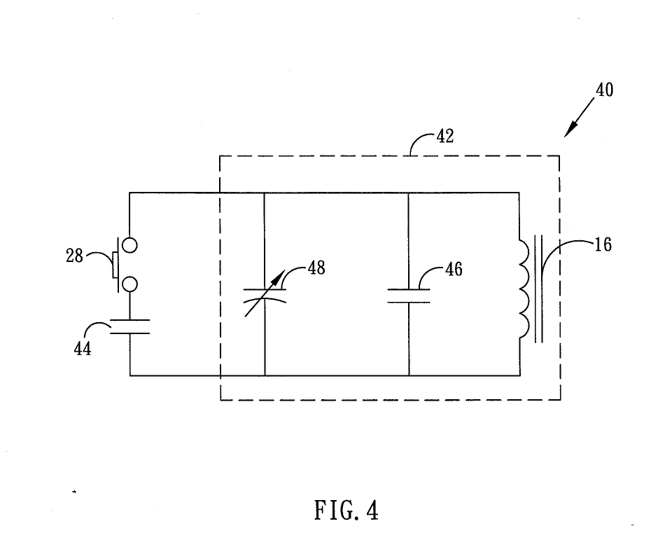

Referring to FIG. 4, it is a diagram illustrating circuit and structure of an independent eraser system (or an erasing function circuit) without battery in accordance with one embodiment of the present invention. The independent eraser system without battery comprises an erasing function circuit 40. The erasing function circuit 40 comprises a resonance circuit 42 for resonating with the electromagnetic signals emitted from the tablet to store energy, a frequency converter 44 for converting the frequency of electromagnetic signals emitted from the resonance circuit 42 and an erasing function switch 28 used to control whether the frequency converter 44 participates in resonance of the resonance circuit 42.

The frequency converter 44 is connected with one end of the resonance circuit 42 and the erasing function switch 28 is deposed between the frequency converter 44 and the resonance circuit 42. One end of the erasing function switch 28 is connected with the resonance circuit 42 and another end of the erasing function switch 28 is connected with frequency converter 44. When the independent eraser system (or an erasing function circuit) without battery 40 does not turn on the erasing function switch 28, the circuit between the resonance circuit 42 and the frequency converter 44 is not connected. Therefore, the frequency converter 44 does not participate in resonance of the resonance circuit 42. The resonance circuit 42 resonates with the signal emitted by the tablet to produce electric energy or power and then the electric energy or power is stored in the resonance circuit 42 for providing the electric energy or power to the independent eraser system (or an erasing function circuit) without battery 40 to emit the signals. Therefore, it is not necessary for the eraser system to work with battery for providing the electric energy or power to the independent eraser system (or an erasing function circuit) without battery 40. After the erasing function switch 28 is turned on, the circuit between the frequency converter 44 and the resonance circuit 42 is connected. Therefore, the frequency converter 44 participates in resonance of the resonance circuit 42 to convert the frequency of the original signals emitted from the independent eraser system 40 into the frequency of the pre-determined erasing signals. By this way, the tablet detects the signals emitted from the independent eraser system (or an erasing function circuit) without battery 40 and determines whether the signals are the erasing signals emitted by the independent eraser system (or an erasing function circuit) without battery 40. If the tablet recognizes that the signals are the erasing signals defined by the tablet, erasing on the tablet by the independent eraser system (or an erasing function circuit) without battery 40 is performed according the signals.

The independent eraser system without battery 40 is also independent and separated from the digital pen to be an independent device so it is different from the conventional eraser device which is deposed on the digital pen and can not be operated or used independently. Therefore, the independent eraser system 40 provide in this invention can be operated or used independently and the convenience of using or operating the independent eraser system 40 is increased and improved.

The resonance circuit 42 is a LC resonance circuit made by a converter 16, a main capacitor 46 and a variable capacitor 48. The converter 16, the main capacitor 46 and the variable capacitor 48 are connected with each other in order and in parallel. The main capacitor 46 is deposed between the converter 16 and the variable capacitor 48. The converter 16 is and induction coil.

In the independent eraser system (or an erasing function circuit) without battery 40 illustrated in FIG. 4, the erasing function switch 28 is a rotating switch deposed at one side of the independent eraser system without battery 40, or the erasing function switch 28 is a pressure switch or a button deposed at one side of the independent eraser system without battery 40, but not limit. However, the erasing function switch can be design to be any form according to the need for operating or using. The frequency converter 44 is a capacitor.

Therefore, this invention provides an independent eraser system capable of being applied to a tablet or a digitizer coordinate system. The independent eraser system is independent and separated from the digital pen to be an independent device. By this way, both of the independent eraser system and the digital pen are used and operated independently so it is convenient for the user to use or operate the independent eraser system. Furthermore, this invention provides an independent eraser system without battery for applying the independent eraser system without battery to a tablet or a digitizer coordinate system without battery.

What is claimed is:

1. An independent eraser system with a battery wherein said independent eraser system has a erasing function circuit, said erasing function circuit comprising:
a power supplier for providing the electric energy wherein one end of said power supplier is connected with a first ground;
an oscillating circuit connected with one of said power supplier for providing electric signals; and
a converter for converting said electric signals provided by said oscillating circuit into magnetic signals wherein two nodes of said converter are connected with said oscillating circuit.

2. The independent eraser system with a battery of claim 1, further comprising a boost regulator circuit deposed between said power supplier and said oscillating circuit for supplying stable electric energy to said oscillating circuit.

3. The independent eraser system with a battery of claim 2, further comprising a timing-and-power-saving circuit connected with said boost regulator circuit for controlling said independent eraser system into a power-saving mode.

4. The independent eraser system with a battery of claim 3, wherein said timing-and-power-saving circuit controls said boost regulator circuit to shut down said oscillating circuit into said power-saving mode when said independent eraser system with a battery idles in a while.

5. The independent eraser system with a battery of claim 1, further comprising a stabilizer for stabilizing the power voltage of said oscillating circuit wherein one node of said stabilizer is connected with said oscillating circuit and a second ground.

6. The independent eraser system with a battery of claim 5, wherein said stabilizer comprises a capacitor for providing enough electric current immediately to maintain stability of said power voltage of said oscillating circuit when said oscillating circuit needs large electric current.

7. The independent eraser system with a battery of claim 6, wherein one node of said capacitor is connected with a Vcc power and another node of said capacitor and said oscillating circuit are connected with said second ground together.

8. The independent eraser system with a battery of claim 1, wherein said converter, said oscillating circuit and said power supplier are connected with each other in parallel.

9. The independent eraser system with a battery of claim 8, wherein said oscillating circuit and said power supplier are connected with said first ground together.

10. The independent eraser system with a battery of claim 9, further comprising an erasing function switch deposed between said oscillating circuit and said power supplier for controlling a circuit between said oscillating circuit and said power supplier to be on or off.

11. The independent eraser system with a battery of claim 10, further comprising a boost regulator circuit deposed between said oscillating circuit and said erasing function switch for supplying stable electric energy to said oscillating circuit, and said boost regulator circuit is connected with said oscillating circuit and said power supplier in parallel.

12. The independent eraser system with a battery of claim 11, further comprising stabilizer for stabilizing the power voltage of said oscillating circuit wherein one node of said stabilizer is connected with said oscillating circuit and said first ground.

13. The independent eraser system with a battery of claim 12, wherein said stabilizer comprises a capacitor for providing enough electric current immediately to maintain stability of said power voltage of said oscillating circuit when large electric current is necessary.

14. The independent eraser system with a battery of claim 13, wherein one node of said capacitor is connected with a Vcc power, and another node of said capacitor, said oscillating circuit, said boost regulator circuit and said power supplier are connected with said first ground together.

15. The independent eraser system with a battery of claim 9, wherein said erasing function switch is a rotating switch deposed at one side of said independent eraser system with a battery.

16. The independent eraser system with a battery of claim 9, wherein said erasing function switch is a pressure switch or a button deposed at one side of said independent eraser system with a battery.

17. The independent eraser system with a battery of claim 1, wherein said converter is a coil.

18. The independent eraser system with a battery of claim 1, wherein said power supplier is a battery.

19. An independent eraser system without battery wherein said independent eraser system has a erasing function circuit, said erasing function circuit comprising:
a resonance circuit for resonating with electromagnetic signals emitted from a tablet to store energy for supplying energy to said independent eraser system without battery;
a frequency converter connected with one node of said resonance circuit for converting the frequency of electromagnetic signals emitted from said resonance circuit; and
an erasing function switch used to control said frequency converter to participate in resonance of said resonance circuit wherein one node of said erasing function switch is connected with said resonance circuit and another node of said frequency converter.

20. The independent eraser system without battery of claim 19, wherein said resonance circuit is a LC resonance circuit made by a converter, a main capacitor, and a variable capacitor.

21. The independent eraser system without battery of claim 20, wherein said converter, said main capacitor and said variable capacitor are connected with each other in order and in parallel.

22. The independent eraser system without battery of claim 20, wherein said frequency converter is a capacitor.

23. The independent eraser system without battery of claim 20, wherein said converter is an coil.

24. The independent eraser system without battery of claim 19, wherein said erasing function switch is a rotating switch deposed at one side of said independent eraser system without battery.

25. The independent eraser system without battery of claim 19, wherein said erasing function switch is a pressure switch or a button deposed at one side of said independent eraser system without battery.

26. The independent eraser system without battery of claim 19, wherein a circuit between said frequency converter and said resonance circuit is on and said frequency converter participates in resonance of said resonance circuit when said erasing function switch is turned on.
